(19) United States
(12) Patent Application Publication
(10) Pub. No.: US 2009/0026310 A1
(43) Pub. Date: Jan. 29, 2009

(54) Variable pitch anti torque coaxial counter rotation bi-prop rotor

(76) Inventor: Romeo S. Linn, San Jose, CA (US)

Correspondence Address: LINVENTS CENTURY LABS INC.;ROMEO S. LINN, 1971 OTOOLE WAY, SAN JOSE, CA, 95131, US

(21) Appl. No.: 11/880,431

(22) Filed: Jul. 23, 2007

(51) Int. Cl. B64C 11/46

(52) U.S. Cl. 244/65

(57) ABSTRACT

Single engine aircrafts, spot light, seaplanes, ultra-light planes, gyro-planes, power parachutes, trikes, airship etc commonly use fixed pitch low efficiency propellers that generate unbalancing torque. Pilots need to make offset turning to anti-torque. The subject novel anti torque coaxial counter rotation Bi-Prop Rotor fill out the empty of such variable and reversible thrust anti-torque propulsion device. The Bi-Prop Rotor comprises an on axis driving compact unobvious gear box; 2 sets multiple blades prop-rotors with variable pitch push rods and bearing-plate assemblies, co-axial tandem mounted at both sides of the gear box; a set sliding bridge mechanism that synchronized the tandem prop-rotors blade pitch turning; and a driving pulley chain or bell driving system. When engine power up the driving pulley, the primary prop-rotor mounted with the pulley rotates, and drives the gear box. The gear box converts rotation to counter direction in the same RPM, and drives the second prop-rotor on axis end rotating. This bi-prop rotor has multiple unique features: A, anti-torque; B, linear vary blade pitch angle and thrust; C, can reverse blade pitch direction to produce reversed thrust to do air speed deceleration, or air braking; D, has extraordinary aerodynamic efficiency; E, substantially produces a lot more thrust with same engine power.

### FIELD OF THE INVENTION

This invention relates to aircraft novel anti-torque bi-Prop Rotor propulsion system.

### BACKGROUND OF THE INVENTION

In the industries of single engine aircrafts, like fixed wing light planes, spot light planes, ultra-light planes, gyro-planes, power parachutes, trike (power hang gliders), airship etc. a single engine driving a single propeller is a main stream and standard configuration. Thus, FAA set the single engine private pilot license for operating these small private aircrafts categories.

There are a few characteristic problems to popular single engine driving single propeller aircrafts. The first well-know problem is the rotation torque. If a propeller is rotating at clockwise direction, a torque tendency forces the aircraft fuselage rotate to same clockwise direction along the longitudinal axis. The torque affects the most while stating the prop spinning, and while the prop is accelerating RPM rotation. To minimize the torque disturbing, The single propeller in most of light aircrafts is governed as Quasi Constant Speed RPM (QCS tech) during flight. RPM Acceleration operation must be slow during flight. And flight trimming is needed to co-operate with the RPM acceleration to offset the torque from the prop. The flight trimming keeps the pilot busy enough and high tension.

The second characteristic problem is the low efficiency of propulsion. To produce high thrust, high RPM or large diameter size prop is required. High RPM leads to lousy noise, and large diameter with high RPM will push blades tips near to speed of sound and making blasting noise.

The third problems to most of single prop aircrafts is the fixed pitch low efficiency propeller. Some adjustable pitch propellers are only adjustable on ground.

Technology Breakthrough

Introducing a Variable Pitch Anti Torque Coaxial Counter Rotation Bi-Props Rotor. driving by an on axis compact, symmetrical unobvious gear box. After over 100 years of invention of the first aircraft propeller, now a new generation Variable Pitch Anti Torque Coaxial Counter Rotation Bi-Prop Rotor give birth. Light aircrafts, ultra-light aircrafts, gyro-crafts, Trikes, power hang gliders makers and builders now can get the perfect anti-torque ultra efficient prop-rotor to replace common fixed pitch propellers. No more need pilots busy trimming to keep straight flight; no even need the trim tab control system in single propeller aircrafts.

The variable pitch counter coaxial 4 blades structural bi-prop rotor can produce extremely high thrust while rotating at moderate RPM, yet pretty quiet, streamline smooth, ultra efficient. The ultra compact, dual gearing driving high torque un-obvious gear box is the keys to make counter rotation possible.

Unique Features of The Bi-Prop Rotor:
1. Anti torque. No need trim tabs control system on the applied aircraft;
2. Free will to accelerate and decelerate the aircraft without the need of pilot's trimming operation to make straight flight;
3. Torque-less make variable RPM possible for better flight maneuvering;
4. Variable pitch make easy to accelerate and to decelerate, for better flight maneuvering;
5. Capable reverse pitch to produce negative thrust for air break while utilizing symmetrical airfoil on all blade chords;
6. Dual of dipole prop rotor produces substantial higher thrust than same diameter 4 blades common propeller at same RPM speed;
7. Can spin at lower RPM to make same thrust as advanced quasi constant RPM propellers. Lower RPM benefits to lower drag, low vibration, quiet, lower fuel consumption;
8. The Anti torque bi-prop rotor make easy to apply on and power VTOL aircrafts, and to make the VTOL aircraft precisely float in air.
10. The Anti torque bi-prop rotor can be configured as pull setting or push setting to apply on single engine variety aircrafts like private light aircraft, Ultra light aircrafts, gyro-planes, gyrocopters, powered hang gliders, powered parachute, space ship etc.

Key propulsion system for VTOL aircrafts. VTOL aircrafts are the most expected air vehicles prior to any other type of aircraft cause their versatility and no need air field, and able to travel door to door transportation. To make VTOL aircrafts static hovering or floating on air, torque-less single engine propulsion system is needed to anti gravity. Before this torque-less bi-prop rotor going available, VTOL aircraft designers met tremendous difficulty to configure propelling system. Now the birth of this anti torque bi-prop rotor is an exciting breaking news to them and make their dream coming true.

### BRIEF DESCRIPTION OF THE DRAWINGS

FIG. 1 is top view of the Bi-Rotor Propeller;

FIG. 2 is front view of the Bi-Rotor Propeller;

FIG. 3A is the high torque gear box; 3B is the pitch control rod; 3C is the slave pulley;

FIG. 3D is the longitudinal axis; 3E is the primary pulley driving by a engine.

FIG. 4A is the pitch control rod;

FIGS. 4B, 4C are the pitch control horn;

FIGS. 4D, 4E are the co-axial dual rotors.

FIG. 5A is the mounting end of the longitudinal axis; 5B is the spinning end of the axis.

FIGS. 5C, 5D is the perpendicular tab cross for mounting the co-axis gearbox assembly.

FIG. 5E is the compact co-axis gearbox assembly.

FIG. 5F is the mechanical spinning input port; 5G is the mechanical spinning output port.

FIGS. 6A, 6B is the rotate-able hollow cylinder.

FIG. 7A is the tandem pitch control rods and bearing plate assembly.

FIG. 7B are the bearing plates. 7C are the sliding rods,

FIGS. 7B and 7C forms the longitudinal sliding bridge mechanism.

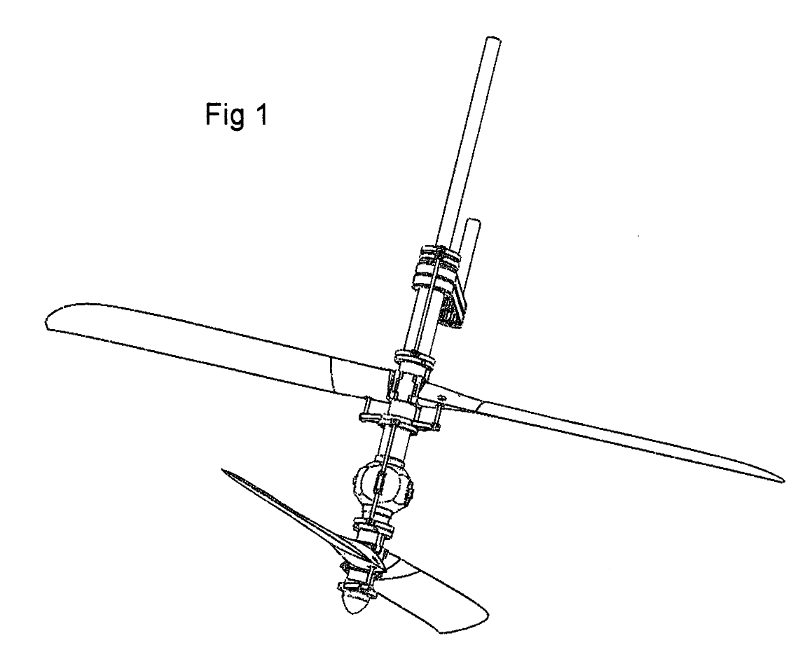

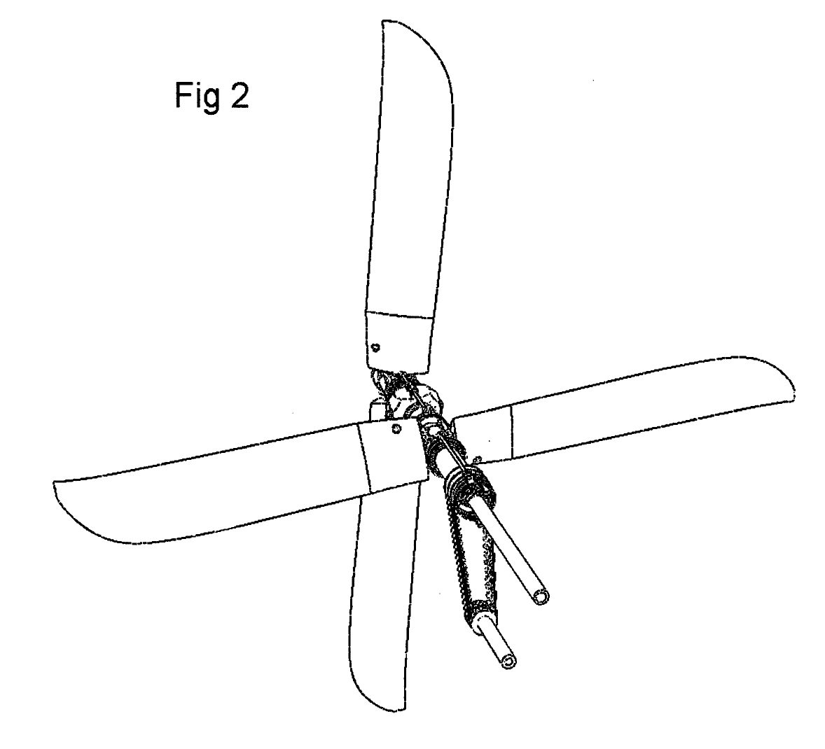

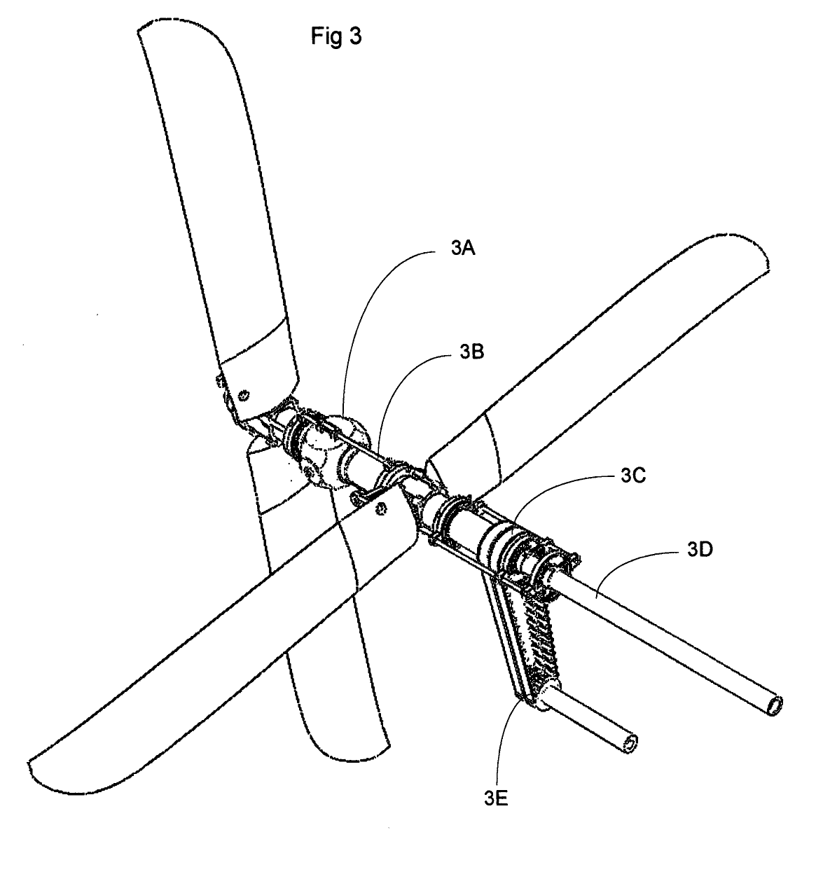

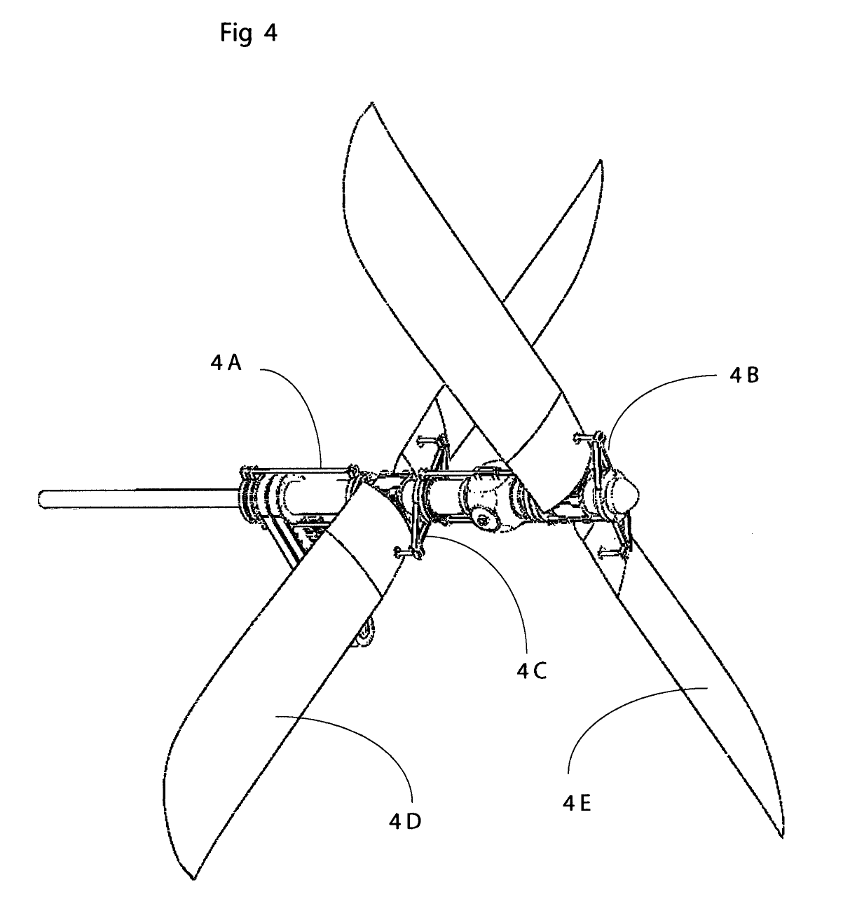

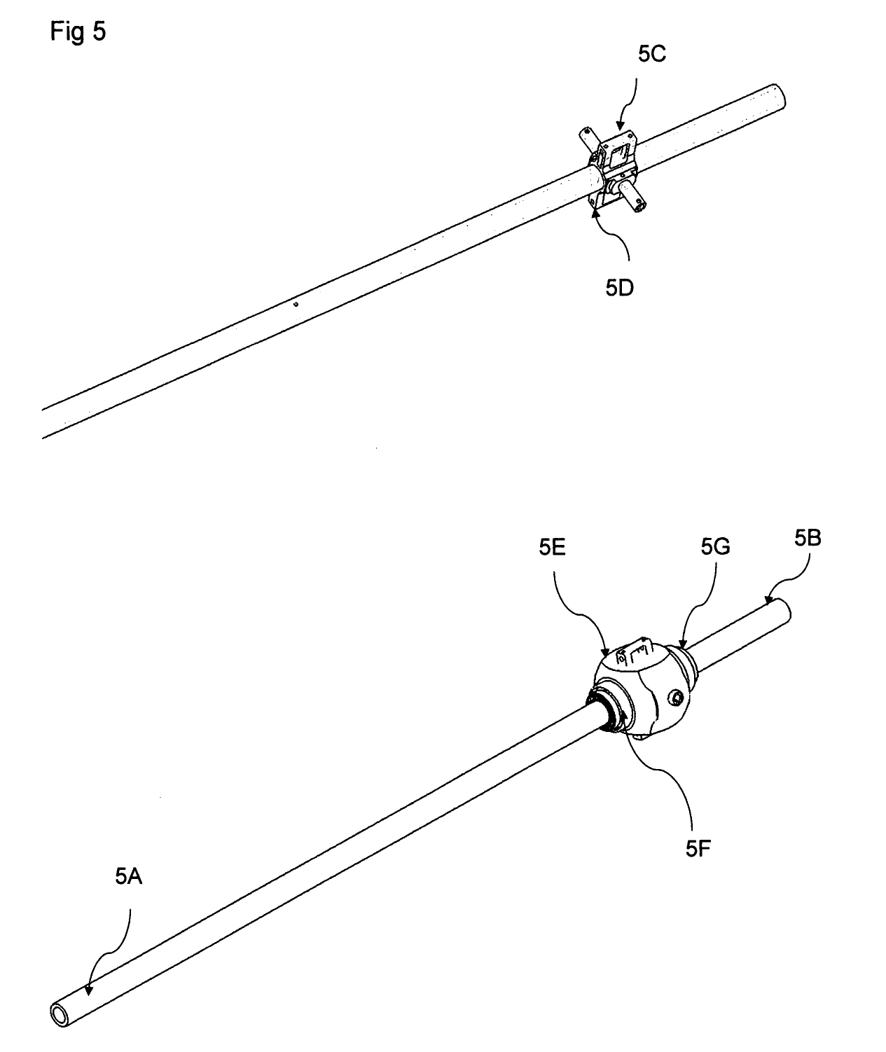

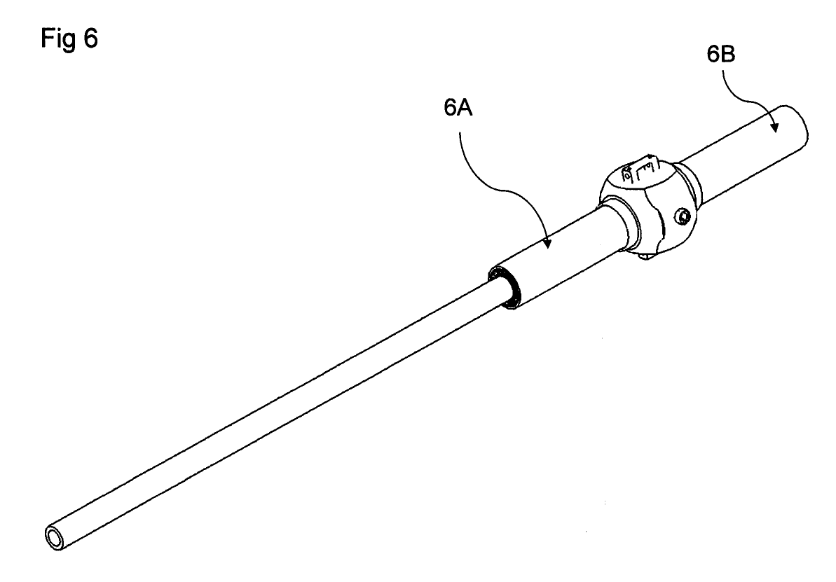

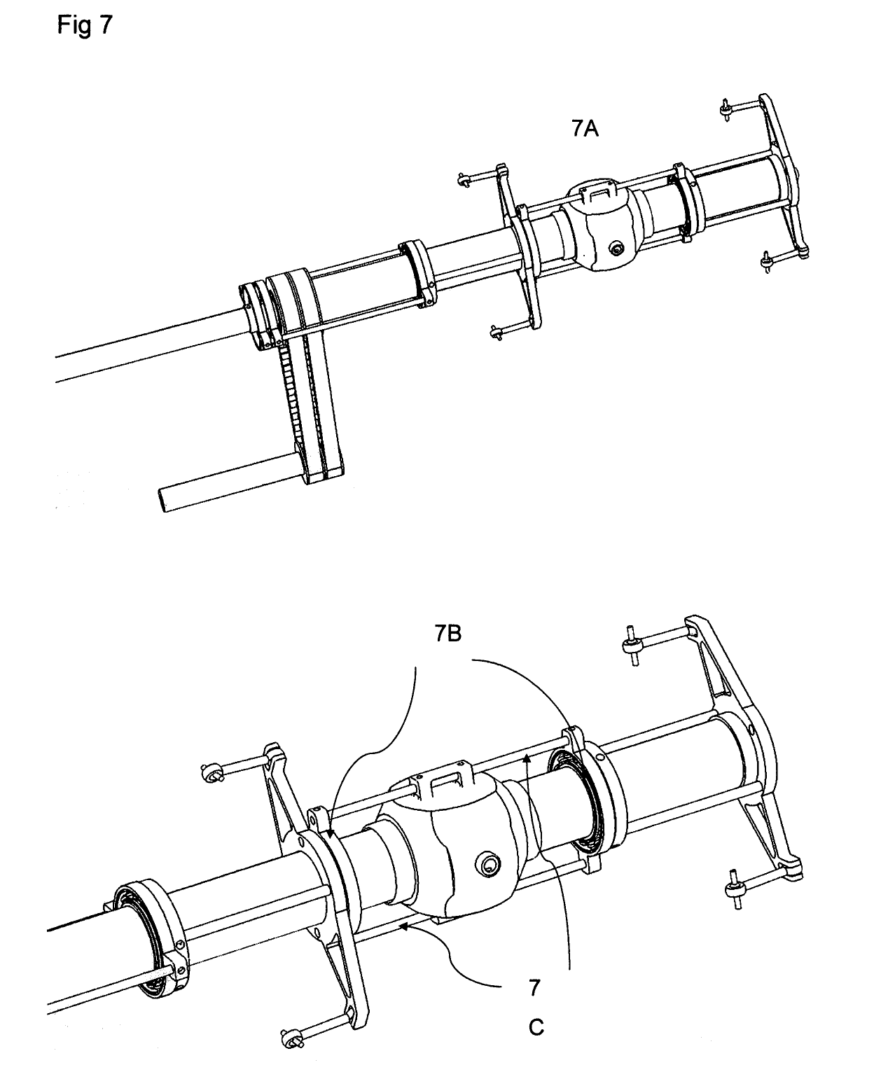

What is claimed is:

1. A variable pitch anti Torque coaxial counter rotation Bi-Prop Rotor, comprise:
a longitudinal axis, having a spinning end and a mounting end that is mounted in an aircraft;
an co-axis gearbox assembly, having a mechanical spinning input port, co-axial with said longitudinal axis, and a counter spinning output port that spin on the spinning end of said longitudinal rigid axis;
2 rotate-able hollow cylinders, tandem mounted on both the mechanical spinning input port and counter spinning output port of said co-axis gearbox assembly, and counter rotating on said longitudinal axis;
plural forward rotation rotor blades, even angular and symmetrical mounted on one of said 2 rotate-able hollow cylinders;
plural counter rotational rotor blades, even angular and symmetrical mounted on the other of said 2 rotate-able hollow cylinders;
2 sets pitch control rods and bearing plate assemblies, varying collective pitches of said plural forward rotation rotor blades and counter rotational rotor blades;
a set longitudinal sliding bridge mechanism, connecting the 2 sets pitch control rods and bearing plate assemblies together to slide back and forth on longitudinal axis for synchronized collective pitch control;
a set driving pulley, driving chain or belts assembly, transferring engine power to the coaxial counter rotation Bi-Prop Rotor.

2. The variable pitch anti Torque coaxial counter rotation Bi-Prop Rotor of claim 1, wherein said longitudinal axis, comprises a perpendicular tab cross for mounting the co-axis gearbox assembly.

3. The variable pitch anti Torque coaxial counter rotation Bi-Prop Rotor of claim 1, wherein said co-axis gearbox assembly, comprises plural gears to convert mechanical rotation to counter rotation, and a chamfered edge cubic seal holder.

4. The variable pitch anti torque coaxial counter rotation Bi-Prop Rotor of claim 1, wherein said a set longitudinal sliding bridge mechanism comprises:
a pair guiding tabs, dipole mounted on top of the cubic holder of the co-axis gearbox assembly;
a pair of sliding rods, going through said a pair holed guiding tabs;
a pair of bearing rings, mounted at both ends of the pair of sliding rods to form the rigid sliding bridge mechanism.

5. The variable pitch anti torque coaxial counter rotation Bi-Prop Rotor of claim 4, wherein the pair of bearing rings, separately co-axial mounted together with each of the 2 sets pitch control rods and bearing-plate assemblies, so that to have the 2 sets pitch control rods and bearing-plate assemblies tandem moving together via the sliding bridge mechanism for collective pitch control.

6. The variable pitch anti torque coaxial counter rotation Bi-Prop Rotor of claim 1, wherein said a set driving pulley, driving chain or belts assembly, comprises:
a secondary driving pulley, co-axial and near to mounting end of the longitudinal axis, a primary driving pulley, on axis of any giving engine, and having smaller diameter and less teeth for speed RPM transfer reduction;
a set driving chain or belts, having teeth to transfer mechanical power from any giving engine to the secondary driving pulley.

7. The variable pitch anti torque coaxial counter rotation Bi-Prop Rotor of claim 1, wherein said 2 sets pitch control rods and bearing-plate assemblies for the coaxial counter rotation Bi-Prop Rotor, are able to co-turning collective pitch from forward angle to backward angle, so as to reverse thrust backward to forward direction for aircraft air speed decelerating or air braking.
